(19) United States
(12) Patent Application Publication
(10) Pub. No.: US 2011/0167567 A1
(43) Pub. Date: Jul. 14, 2011

(54) Dye Transfer Inhibition Composition

(75) Inventor: Giuseppe DiBono, Mira (IT)

(73) Assignee: Reckitt Benckiser N.V., Hoofddorp (NL)

(21) Appl. No.: 12/988,695

(22) PCT Filed: Apr. 27, 2009
(86) PCT No.: PCT/GB2009/001071

§ 371 Date: Feb. 22, 2011

(30) Foreign Application Priority Data
Apr. 25, 2008 (GB) 0807568.1
Apr. 30, 2008 (GB) 0807794.3

(51) Int. Cl. D06L 1/20; C11D 17/00; C08B 15/06

(52) U.S. Cl. 8/137; 510/297; 536/30

(57) ABSTRACT

A composition comprises a fibre material. The fibre has been treated by reaction with a molecule having the following formula:

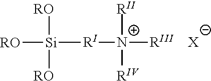

wherein R is an alkyl group having 1 to 20 carbon atoms, preferably 1 to 5 carbon atoms and more preferably 1 to 3 carbon atoms.

wherein R^{I} is an alkyl group having 1 to 20 carbon atoms, preferably 1 to 5 carbon atoms and more preferably 2 to 5 carbon atoms.

wherein R^{II} is an alkyl group having 1 to 20 carbon atoms, preferably 1 to 10 carbon atoms and more preferably 1 to 5 carbon atoms.

wherein R^{III} is an alkyl group having 1 to 20 carbon atoms.

wherein R^{IV} is an alkyl group having 1 to 20 carbon atoms, preferably 1 to 10 carbon atoms and more preferably 1 to 5 carbon atoms.

wherein X is a halide, preferably one of Cl⁻, Br⁻ or I⁻.

### COMPOSITION

This invention relates to a composition, to a method for its preparation, a product comprising the composition and to its use in a washing method.

Dye transfer inhibition compositions have been available for some time. These compounds find use in laundry washing compositions to aid the prevention of dye transfer from one garment to another during a wash cycle, e.g. dye from a red item of clothing being transferred to a white item of clothing which could cause the white item to turn pink.

Commonly the dye transfer inhibition composition is an integral part of the detergent formulation whether in liquid/powder form, and thus enters the wash liquor with the remainder of the detergent formulation.

Alternatively the dye transfer inhibition composition may be immobilised on a support. In this way the dye transfer inhibition composition does not actually enter the wash liquor by being dissolved/dissipated therein but is still able to influence the wash liquor and prevent dye transfer therein by interaction therewith.

The support materials typically comprises a fabric/fabric material such as cellulose, polyester or a polyolefin. These may be in the form of a sheet or a pouch.

The active part of the dye transfer inhibition composition in these immobilised products is usually based on a quaternary ammonium species which is bound, as a rule in a chemical fashion, to the support.

One major problem with the immobilised dye transfer inhibition compositions and more particularly their production is that the chemical involved in the production are highly toxic. This is because the quaternary ammonium moiety is typically bound to the support material through a reactive epoxide moiety, which reacts with the support fibre, typically through a hydroxyl group. Due to the presence of the epoxide moiety the production has to be performed in highly controlled manner. Furthermore, extreme care has to be taken to ensure that any un-reacted dye transfer inhibition composition reactant is removed from the support material as otherwise toxicity problems would be caused when a consumer was brought into contact with the product. This means that a huge amount of water (more than 50 kg per kg of finished product) is required to remove residuals thoroughly.

Thus there is a need to provide an alternative dye transfer inhibition composition immobilised on a support and an improved method of making same.

According to a first aspect of the present invention there is provided a composition comprising a fibre material wherein the fibre has been treated by reaction with a molecule having the following formula:

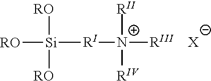

wherein R is an alkyl group having 1 to 20 carbon atoms, preferably 1 to 5 carbon atoms and more preferably 1 to 3 carbon atoms.
wherein R^{I} is an alkyl group having 1 to 20 carbon atoms, preferably 1 to 5 carbon atoms and more preferably 2 to 5 carbon atoms.
wherein R^{II} is an alkyl group having 1 to 20 carbon atoms, preferably 1 to 10 carbon atoms and more preferably 1 to 5 carbon atoms.
wherein R^{III} is an alkyl group having 1 to 20 carbon atoms.
wherein R^{IV} is an alkyl group having 1 to 20 carbon atoms, preferably 1 to 10 carbon atoms and more preferably 1 to 5 carbon atoms.
wherein X is a halide, preferably one of Cl⁻, Br⁻ or I⁻

It has been found that by using the molecule an effective dye transfer inhibition composition can be provided wherein the dye transfer inhibition active is immobilised on a support through the alkoxysilyl group. Additionally these advantages are observed without encountering any of the toxicity/production problems of the prior art since the molecule is sufficiently reactive to form a bond with a support fibre without displaying any of the toxicity issues observed previously.

Preferably the molecule has the following formula:

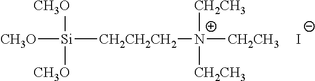

Generally the fibre material includes one or more reactive groups to react with the molecule. Suitably the fibre material includes a hydroxyl group. It is understood that such reactive groups will react with the silicon part of the molecule, displacing the alkoxy group attached to the silicon atom and forming a new Si—O—C bond (a hydrogen atom is lost from the hydroxyl group).

Further it is recognised that the silicon part of the molecule undergoes a further reaction. This further reaction is presumably due to displacement of the alkoxy group from the silicon part of the molecule and replacement with hydroxyl groups. Consequently reaction with the silicon part of one or more other molecules can occur to form one or more new Si—O—Si bonds. In doing so the molecule is telomerised to a degree.

Preferred examples of appropriate fibre materials include fibre materials which comprise cellulose, e.g. cotton or viscose. These materials may be pure or may be blended with other fibres, e.g. synthetic fibres, like polyester, polypropylene, polyamide, etc.

The composition may be in any suitable form. Preferred forms include fibres and coalesced fibrous products such as felts. The fibres may be woven/nonwoven. Alternatively the composition may comprise a product in the form of a sheet. Preferred lengths/widths are in the range of 5-30 cm, e.g. 6 cm, 10 cm, 12 cm, 15 cm, 20 cm, 25 cm or 30 cm.

It is more preferred that the product is in the form of a sachet formed from at least two sheets of material. Of these at least two sheets of material a sheet may comprise fibre in accordance with the invention and a sheet may comprise an alternative fibre material.

Generally the sachet covers a surface (i.e. the product of width and length (when the sachet is rectangular) of between 80 to 300 cm², ideally 100 to 200 cm². Preferred lengths/widths are in the range of 5-30 cm, e.g. 6 cm, 10 cm, 12 cm, 15 cm, 20 cm, 25 cm or 30 cm.

The sachet is preferably flat, i.e. with one dimension, the thickness of the sachet, at least 5 times smaller preferably at least 10 times smaller, ideally at least 30 times smaller than the other two, the width and the length of the sachet (which are the same as each other, corresponding to the diameter of the sachet, should it be circular in plan). Preferred thickness are in the range of 10-20 mm, e.g. 10 mm, 15 mm or 20 mm.

The sachet may comprise a detergent composition. In this case it will be appreciated that either the sachet may be porous to allow the detergent composition to be removed from the sachet or may open in use to allow the detergent composition to be released therefrom.

The exact nature of the detergent formulation used will vary depending on the intended use of the sachet but obviously the detergent composition may comprise one or more of surfactant, enzyme, bleach, solvent, dye transfer inhibitor, bleach activator, fragrance, builder, dye.

Generally the detergent is in the form or a powder. The detergent may comprise soluble/non-soluble components (some non-soluble components may need to be kept in the sachet during its use).

Preferably the total amount of detergent formulation is between 5 and 25 g, ideally between 7 and 20 g.

The sachet comprises a flexible body of at least 10 mm in one dimension and at least 10 mm in another dimension. Preferably the body is such that no dimension is greater than 20 mm. Ideally each dimension is between 10-20 mm, e.g. 12 mm, 15 mm or 18 mm.

In a preferred embodiment the body comprises a foam material which may comprise any suitable material such as polypropylene, polyester and/or PE/EVA. The body may comprise a number of separate elements each being formed of a different material.

The sachet may be made in a process comprising:
a) forming an open sachet from one, two or more sheets;
b) filling the open sachet with a detergent composition; and
c) sealing the sachet.

The sachet is preferably packaged in a secondary packaging.

According to a second aspect of the invention there is provided a process for the production of a modified fibre material comprising reacting a fibre material with a molecule having the following formula:

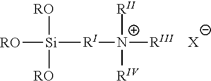

The reaction is preferably performed in aqueous solution. The preferred pH is from 0 to 10, more preferably 2 to 7 and most preferably 3 to 6.

The reaction is preferably performed at a temperature between 10 and 80° C., preferably between 20 and 60° C.

The reaction time may be up to 5 hours.

The reacted fibre may be cured at a temperature of 100 to 130° C. for 5 to 60 min and dried at 25 to 100° C.

According to a third aspect of the invention there is provided the use of a composition comprising a fibre material wherein the fibre has been treated by reaction with a molecule having the following formula:

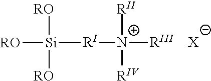

as a dye/dirt catcher in a washing operation.

It shall be appreciated that the features of the first aspect of the invention shall apply mutatis mutandis to the third aspect of the invention.

Preferably the use is in washing laundry in a laundry washing machine.

The composition may be placed with the items to be washed in an automatic washing machine.

Alternatively the composition may pack into the flow pathway for the rinse or wash water of a ware washing machine such that the water is compelled to flow through it.

Alternatively the use in accordance with the third aspect of the invention may be a manual method, for example using a hand-cloth or mop, and an open vessel, for example a bucket or bowl.

The invention will now be described, by way of embodiment, with reference to the following example.

### EXAMPLE

A cellulose-based (80% cellulose, 20% synthetic fibres) nonwoven sheet having dimensions of A4 size (30 cm×20 cm), having weight of 70 g/m² was been treated with acidic (pH 3.76 and 5.84) aqueous solution of

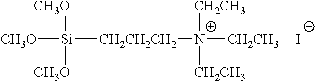

at 15% w/w.

The nonwoven sheet was dipped into the solution for 10 minutes and for 4 hours, in both cases at 25° C., then cured for 60 min at 130° C. and dried at 25° C.

The sheet was then cut into samples having a size of 6 cm×6 cm.

The samples showed dye catching activity when a sample was dipped for 5 min in 100 ml of a solution at 25 mg/l of Direct Blue 71 dye. The same solution contained laundry detergent at 6.25 g/l concentration.

1. A composition comprising a fibre material, 1 wherein the fibre has been treated by reaction with a molecule having the following formula: 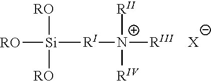
wherein:
R is an alkyl group having 1 to 20 carbon atoms, preferably 1 to 5 carbon atoms and more preferably 1 to 3 carbon atoms;
R^{I} is an alkyl group having 1 to 20 carbon atoms, preferably 1 to 5 carbon atoms and more preferably 2 to 5 carbon atoms;
R^{II} is an alkyl group having 1 to 20 carbon atoms, preferably 1 to 10 carbon atoms and more preferably 1 to 5 carbon atoms;
R^{III} is an alkyl group having 1 to 20 carbon atoms;
R^{IV} is an alkyl group having 1 to 20 carbon atoms, preferably 1 to 10 carbon atoms and more preferably 1 to 5 carbon atoms;
X is a halide, preferably one of Cl⁻, Br⁻ or I⁻.

2. A composition according to claim 1, wherein the molecule has the following formula:

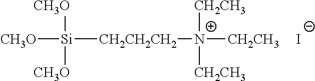

3. A composition according to claim 1, wherein the fibre material includes one or more reactive groups to react with the molecule.

4. A composition according to claim 3, wherein the fibre material includes a hydroxyl group.

5. A composition according to claim 3, wherein the fibre material comprises cellulose.

6. A product comprising the composition of claim 1 in sheet form.

7. A product according to claim 6 wherein the product is in the form of a sachet formed from at least two sheets of material.

8. A product according to claim 7, wherein the sachet comprises a detergent composition.

9. A product according to claim 8, wherein the sachet comprises a flexible body of at least 10 mm in one dimension and at least 10 mm in another dimension.

10. A process for the production of a modified fibre material comprising the step of: reacting a fibre material with a molecule having the following formula:

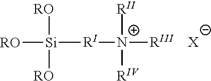

11. A dye/dirt catcher composition comprising a fibre material wherein the fibre has been treated by reaction with a molecule having the following formula: 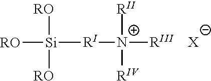
wherein:
R is an alkyl group having 1 to 20 carbon atoms, preferably 1 to 5 carbon atoms and more preferably 1 to 3 carbon atoms;
R^{I} is an alkyl group having 1 to 20 carbon atoms, preferably 1 to 5 carbon atoms and more preferably 2 to 5 carbon atoms;
R^{II} is an alkyl group having 1 to 20 carbon atoms, preferably 1 to 10 carbon atoms and more preferably 1 to 5 carbon atoms;
R^{III} is an alkyl group having 1 to 20 carbon atoms;
R^{IV} is an alkyl group having 1 to 20 carbon atoms, preferably 1 to 10 carbon atoms and more preferably 1 to 5 carbon atoms; and
X is a halide, preferably one of Cl⁻, Br⁻ or I⁻.

12. (canceled)

13. A method of washing laundry in a laundry washing machine, the method comprising the step of: providing a fibre material wherein the fibre has been treated by reaction with a molecule having the following formula: 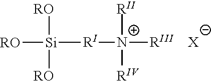
wherein:
R is an alkyl group having 1 to 20 carbon atoms, preferably 1 to 5 carbon atoms and more preferably 1 to 3 carbon atoms;
R^{I} is an alkyl group having 1 to 20 carbon atoms, preferably 1 to 5 carbon atoms and more preferably 2 to 5 carbon atoms;
R^{II} is an alkyl group having 1 to 20 carbon atoms, preferably 1 to 10 carbon atoms and more preferably 1 to 5 carbon atoms;
R^{III} is an alkyl group having 1 to 20 carbon atoms;
R^{IV} is an alkyl group having 1 to 20 carbon atoms, preferably 1 to 10 carbon atoms and more preferably 1 to 5 carbon atoms; and
X is a halide, preferably one of Cl⁻, Br⁻ or I⁻
to the washing machine during a laundry washing process.
